(19) United States
(12) Patent Application Publication
(10) Pub. No.: US 2026/0022723 A1
(43) Pub. Date: Jan. 22, 2026

(54) DOUBLE-ECCENTRIC CONNECTING DEVICE FOR CONNECTING A FIXING LUG TO A CLEVIS AND CONNECTING SYSTEM COMPRISING AT LEAST ONE SUCH CONNECTING DEVICE

(71) Applicants: AIRBUS (S.A.S.), Blagnac (FR); AIRBUS OPERATIONS (S.A.S.), Toulouse (FR)

(72) Inventors: Xavier MATHEIS, TOULOUSE (FR); David COLMAGRO, COLOMIERS (FR)

(21) Appl. No.: 19/273,827

(22) Filed: Jul. 18, 2025

(30) Foreign Application Priority Data
Jul. 19, 2024 (FR) 2407965

(51) Int. Cl. F16B 5/02

(52) U.S. Cl. CPC F16B 5/0283

(57) ABSTRACT

A double-eccentric connecting device for connecting a fixing lug to a clevis and connecting system comprising at least one such connecting device is disclosed. The connecting device includes a main sleeve having a central section inserted into an orifice of the fixing lug and two end sections on either side of the central section, the centers of the external surfaces of the two end sections being offset from the center of the external surface of the central section, as well as two bushings, each of them inserted into an orifice passing through the clevis and mounted on one of the end sections, each of the bushings having an external surface the center of which is offset from the center of its internal surface, the connecting device thus including two eccentric elements, making it possible, through appropriate angular positioning, to compensate for an alignment error between the orifice passing through the fixing lug and the through-orifices of the clevis.

### CROSS REFERENCE TO RELATED APPLICATION

This application claims priority to French Application Number FR 2407965, filed Jul. 19, 2024, the entire contents of which is hereby incorporated by reference.

### BACKGROUND

The present disclosure relates to a device for connecting a fixing lug to a clevis and to a connecting system comprising at least one such connecting device.

The present disclosure applies to the assembly of structural parts or elements of an aircraft, particularly of a transport plane.

More particularly, although not exclusively, it applies to the assembling of a central portion of a single-body aircraft, and notably to the connection of what is known as a keel beam in the belly of the plane to the fuselage of the aircraft. The various interface elements interfacing between a keel beam and the fuselage transfer compressive and tensile loads generated by the flexing of the fuselage during take-off, landing and flight, and/or loads generated as the aircraft taxis along the ground, which loads are transferred to the keel beam from the primary structure.

During assembly of two structural elements, a capacity for adjustment needs to be provided in order to correct for alignment errors in the alignment between the parts that are to be assembled, notably between a mutually collaborating clevis and fixing lug.

For assembly to a keel beam, a capacity for adjustment is generally obtained by giving the interface parts at the fuselage a length or width that is appropriate for allowing counter drilling during assembly. The assembly method employed is relatively lengthy and requires numerous manual operations such as notably drilling, separation, deburring, and cleaning, possibly packing, and assembly using numerous fixings. This method of assembly has to be repeated for each part of the keel beam attached to the fuselage, at each of the ends thereof. In addition, this method is carried out in a non-ergonomic position.

There is therefore still a need to be able to have available a reliable solution for assembling two components, and more particularly a clevis and a fixing lug, that enables correction of a misalignment and that alleviates the above-mentioned disadvantages.

### SUMMARY

The present disclosure contemplates a solution for meeting the above-mentioned need. The invention relates to a device for connecting a fixing lug to a clevis.

According to an exemplary embodiment, the connecting device comprises at least:
a main sleeve including a central section intended to be inserted into a through-orifice of the fixing lug, the central section having, in cross section, a circular external surface of a first diameter, the main sleeve also comprising two end sections which are connected to said central section, respectively one on each side of the central section, the external surfaces of the two end sections having, in cross section, a circular shape of the one same second diameter, said second diameter being different than said first diameter, the centers of said circular external surfaces of the two end sections being offset from the center of the circular external surface of the central section in a transverse plane; and
two bushings, each of them mounted on one of the end sections, with a circular internal surface in contact with the circular external surface of the corresponding end section and intended to be inserted in a through-orifice of the clevis, each of said bushings having an external surface that is circular in cross section and the center of which is offset from the center of its circular internal surface.

Thus, according to an exemplary embodiment, the connecting device comprises two eccentric elements, a first eccentric element obtained by the mutual-offsetting of the end sections and the central section of the main sleeve, and a second eccentric element obtained by the mutual-offsetting of the internal and external surfaces of the bushings. These two eccentric elements make it possible, by angularly (rotationally) positioning the main sleeve, and therefore the central section (in the orifice of the fixing lug) and by angularly (rotationally) positioning the bushings with respect to the sleeve, to adapt the relative positioning of the external circular surface of the central section and the external circular surfaces of the end sections in such a way as to be able to compensate for any misalignment between the through-orifice of the fixing lug and the through-orifices of the clevis.

The fixing lug may thus be connected to the clevis simply and quickly, with a limited number of manual actions, as specified hereinbelow, while at the same time correcting for any misalignment there might be.

Advantageously, the central section of the main sleeve is provided, at one of its longitudinal ends, with a radially projecting flange.

In an exemplary embodiment, the connecting device comprises an internal sleeve which is housed inside said main sleeve, its external surface being in contact with an internal surface of the main sleeve. Furthermore, advantageously, the connecting device comprises, associated with each of the bushings, at least one retaining nut which, under the action of a nut screwed onto a threaded section of the internal sleeve, applies pressure to the bushing to block it against translation.

Furthermore, advantageously, the connecting device comprises a nut and a washer for blocking at least the main sleeve against translation.

Moreover, advantageously, at least one of the following elements has a frustoconical shape:
the main sleeve;
the bushings;
the internal sleeve.

According to an exemplary embodiment, a connecting system connecting a first structural element to a second structural element is disclosed.

According to an exemplary embodiment, the connecting system comprises at least a fixing lug secured to the first structural element and at least one clevis secured to the second structural element and the fixing lug is connected to the clevis using a connecting device as described hereinabove of which the central section of the main sleeve is inserted into a through-orifice of the fixing lug and of which each of the two bushings is mounted in a through-orifice of the clevis, the angular positioning of the main sleeve and the angular positionings of the bushings with respect to the main sleeve being adapted in order to compensate for any misalignment between the axis of the through-orifice of the fixing lug and the axes of the through-orifices of the clevis.

In one particular embodiment, the first structural element corresponds to part of the fuselage and the second structural element corresponds to a keel beam of an aircraft, the connecting system comprises a plurality of fixing lugs secured to the fuselage part and a plurality of clevises secured to one end of the keel beam, and each of said fixing lugs is connected to one of said clevises using a connecting device as described hereinabove.

An exemplary embodiment further relates to a method for fitting a connecting system as above.

According to an exemplary embodiment, said method comprises at least the following steps:
a step of fitting the main sleeve into the orifices of the fixing lug and of the clevis, the main sleeve being angularly positioned in a first position;
a step of fitting the bushings, each of the bushings being angularly positioned in a second position, the first position and the second positions being adapted in order to compensate for any misalignment between the axis of the through-orifice of the fixing lug and the axes of the through-orifices of the clevis; and
a step of fitting clamping and retaining elements.

Advantageously, said method also comprises a step of fitting the internal sleeve inside the main sleeve.

### BRIEF DESCRIPTION OF THE DRAWINGS

The appended figures will make it easy to understand how an exemplary embodiment may be implemented. In these figures, identical references denote similar elements.

FIG. 1 is a schematic partial perspective view of a connection of one end of a keel beam to part of the fuselage of an aircraft, notably using four connecting devices.

FIG. 2 is a longitudinal section through one particular embodiment of a connecting device connecting a fixing lug, partially depicted, to a clevis, likewise partially depicted.

FIG. 3 is a schematic view in cross section, showing a main sleeve forming a first eccentric element.

FIG. 4 is a schematic view in cross section showing a bushing forming a second eccentric element.

FIG. 5 is an enlarged view of part of FIG. 2, showing a projecting flange and the positioning of various elements of the connecting device.

FIG. 6 is an enlarged view of part of FIG. 2, showing the positioning of various elements of the connecting device.

FIG. 7 is the block diagram for a method for fitting such a connecting system.

### DETAILED DESCRIPTION

Some embodiments will now be described with reference to the Figures.

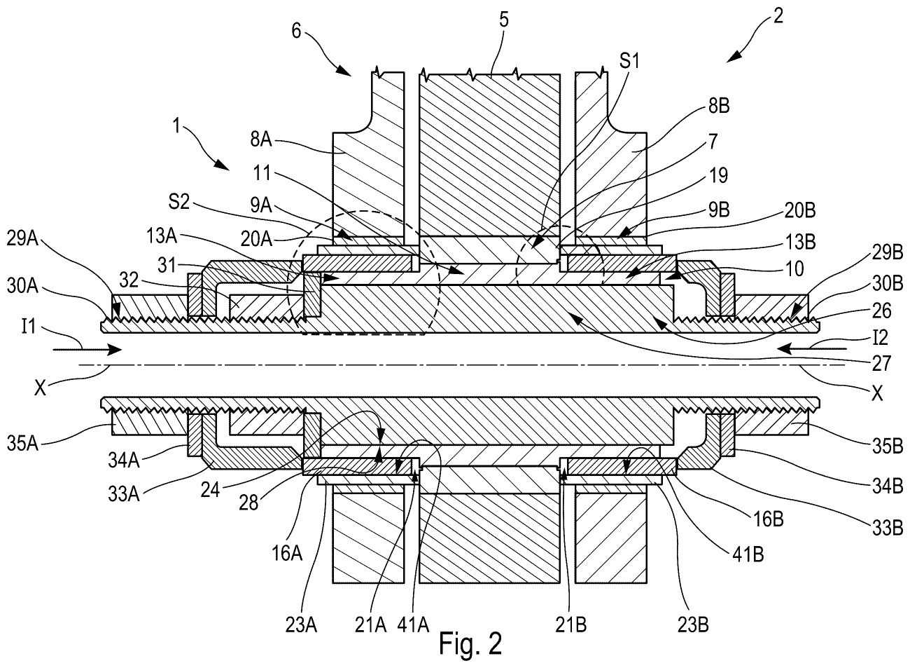

The connecting device (hereinafter “device 1”) illustrating the invention and depicted schematically in one exemplary embodiment in FIG. 2, forms part of a connecting system (hereinafter “system 2”).

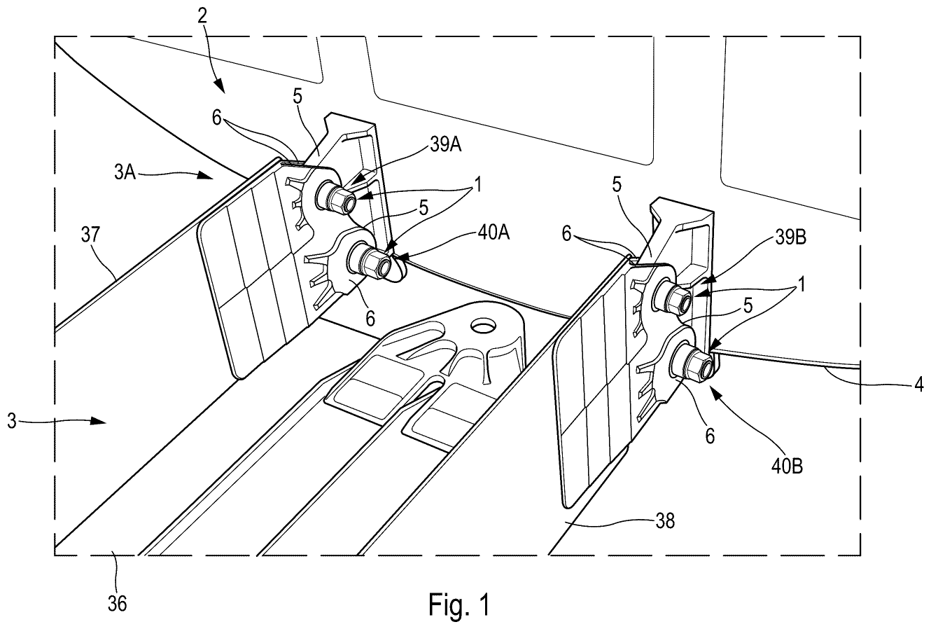

The system 2 is intended for connecting together two structural elements of an aircraft, particularly of a transport plane. In an exemplary embodiment, as depicted in FIG. 1, the system 2 is intended to connect one end 3A of a keel beam 3 to part of the fuselage 4 of the aircraft. In this exemplary embodiment, the system 2 comprises four devices 1, as specified hereinbelow.

Each device 1 of the system 2 is intended to connect a fixing lug 5 to a clevis 6. In the example of FIG. 1, each fixing lug 5 is secured to the fuselage part 4 and each clevis 6 is secured to the end 3A of the keel beam 3.

The fixing lug 5 is provided with a circular through-orifice 7 (FIG. 2). As for the clevis 6, this, as usual, has the overall shape of a U with two branches 8A and 8B depicted partially in FIG. 2, each of which is provided with a circular through-orifice 9A, 9B.

In the description that follows, elements (of the device 1) that are identical and associated with the two branches 8A and 8B are identified by the one same numerical reference, to which the suffix A or B is added, the suffix A denoting that this element is associated with the branch 8A and the suffix B that this element is associated with the branch 8B.

The device 1 is designed to be inserted into the orifices 7, 9A and 9B and to compensate for any offset in alignment of the orifice 7 with respect to the orifices 9A and 9B, namely any offset in a transverse plane (specified hereinbelow) between the centers of the circles of the circular orifices 7, 9A and 9B. To do this, the device 1 comprises a main sleeve 10, produced as a single piece, which comprises a central section 11 of longitudinal axis X-X. This central section 11 is intended to be inserted into the through-orifice 7 of the fixing lug 5.

In the context of an exemplary embodiment:
the adjective “longitudinal” refers to the direction of the axis X-X (FIG. 2) which also corresponds to that of the orifice 7;
the adjectives “internal” and “external” are defined with respect to directions that are radial with respect to this axis X-X, namely, in the case of “internal”, closer to the axis X-X and, in the case of “external”, further from the axis X-X; and
the adjective “transverse” refers to a plane orthogonal to the axis X-X.

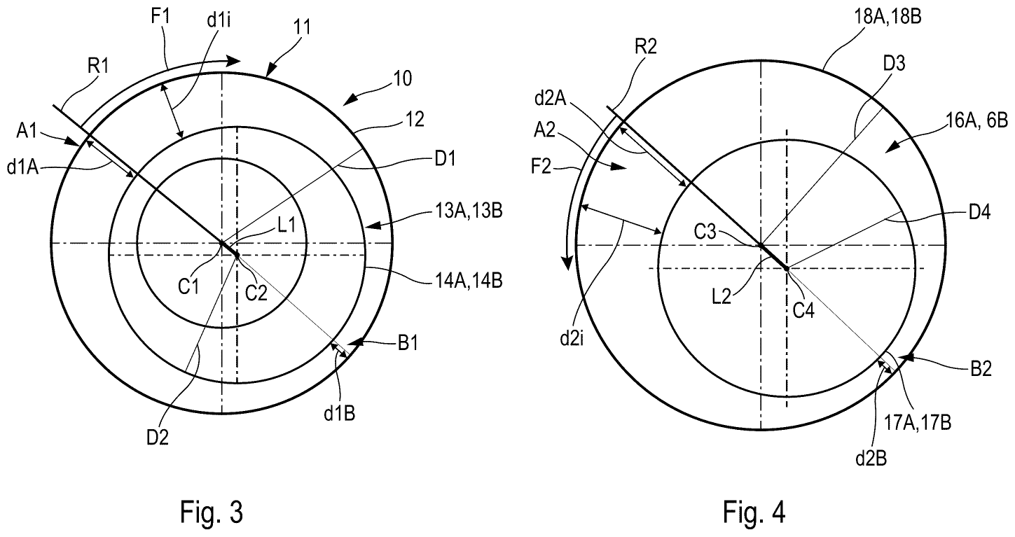

The central section 11 of the main sleeve 10 has, in cross section, a circular external surface 12 of center C1 and diameter D1, as depicted in FIG. 3.

The main sleeve 10 also comprises, as depicted in FIG. 2, two end sections 13A and 13B which are provided respectively one on each side, longitudinally speaking, of said central section 11.

The external surfaces 14A and 14B of the two end sections 13A and 13B have, in cross section, the one same circular shape of center C2 and of diameter D2, as depicted in FIG. 3. In addition, this diameter D2 is smaller than the diameter D1.

The centers C2 of the circular external surfaces 14A and 14B of the two end sections 13A and 13B are offset by a distance with respect to the center C1 of the circular external surface 12 of the central section 11 in a transverse plane, as depicted in FIG. 3. This offset (by a distance L1) makes it possible to create a first eccentric element, as specified hereinbelow. The device 1 additionally comprises two bushings 16A and 16B which are depicted in FIG. 2. Each of these bushings 16A and 16B is intended to be inserted in one of the through-orifices 9A and 9B of the clevis 6.

Each of these bushings 16A and 16B is mounted on one of the end sections 13A and 13B. Thus, the bushing 16A is mounted on the end section 13A in such a way that its circular internal surface 17A (FIG. 4) is in contact with the circular external surface 14A (FIG. 3) of the end section 13A. Likewise, the bushing 16B is mounted on the end section 13B in such a way that its circular internal surface 17B (FIG. 4) is in contact with the circular external surface 14B (FIG. 3) of the end section 13B.

In addition, each of the bushings 16A and 16B has an external surface 18A, 18B that is circular in cross section, of center C3 and diameter D3, and the internal surface 17A, 17B, which is likewise circular in cross section, has a center C4 and a diameter D4, as depicted in FIG. 4.

For each of the bushings 16A and 16B, the center C3 of the circular external surface 18A, 18B is offset by a distance L2 with respect to the center C4 of the circular internal surface 17A, 17B in the transverse plane, as depicted in FIG. 4. This offset (by a distance L2) makes it possible to create a second eccentric element.

Thus, the device 1 therefore comprises two eccentric elements, a first eccentric element obtained by the mutual offsetting of the end sections 13A and 13B and the central section 11 of the main sleeve 10, and a second eccentric element obtained by the mutual offsetting of the internal surfaces 17A and 17B and external surfaces 18A and 18B of the bushings 16A and 16B. The effects of the two eccentric elements are combined, as specified hereinbelow.

The distance d1i between the external surface 12 of the central section 11 and the external surface 13A, 13B of each of the bushings 16A, 16B, in the transverse plane, varies according to the angular position thereof, namely according to its position along the external surface 12 (which is curvilinear in cross section). FIG. 3 depicts a reference segment R1 passing through the centers C1 and C2. At one end A1 along the reference segment R1, the distance d1A between the external surface 12 and the external surface 13A, 13B is at its longest, and at the other end B1, along the reference segment R1, the distance d1B between the external surface 12 and the external surface 13A, 13B is at its shortest. Between these two angular positions, by rotating in the direction illustrated by an arrow F1 (or in the opposite direction to this arrow F1), the distance d1i decreases from the distance d1A to the distance d1B.

The distance d2i between the external surface 18A, 18B and the internal surface 17A, 17B of each bushing 16A, 16B, in the transverse plane, varies according to the angular position thereof, namely according to its position along the external surface 18A, 18B (which is curvilinear in cross section). FIG. 4 depicts a reference segment R2 passing through the centers C3 and C4. At one end A2 along the reference segment R2, the distance d2A between the external surface 18A, 18B and the internal surface 17A, 17B is at its longest, and at the other end B2, along the reference segment R2, the distance d2B between the external surface 18A, 18B and the external surface 17A, 17B is at its shortest. Between these two angular positions, by rotating in the direction illustrated by an arrow F2 (or in the opposite direction to this arrow F2), the distance d2i decreases from the distance d2A to the distance d2B.

These two eccentric elements make it possible, by suitable angular positioning of the main sleeve 10 and therefore of the central section 11 in the orifice 7 of the fixing lug 5, this positioning being obtained by rotating the main sleeve 10, and by angular positioning of the bushings 16A and 16B with respect to the main sleeve 10, this positioning being obtained by rotating the bushings 16A and 16B with respect to the main sleeve 10, these two angular positionings being adapted to suit one another and collaborating with one another, to regulate the relative positioning between the circular external surface 12 of the central section 11 and the circular external surfaces 18A and 18B of the bushings 16A and 16B in such a way as to be able to compensate for an error in alignment between the through-orifice 7 of the fixing lug 5 and the through-orifices 9A and 9B of the clevis 6.

By way of nonlimiting illustration, the offset L1 between the centers C1 and C2 is comprised between 0.5 and 3 mm and is preferably of the order of 1.5 mm, and the offset L2 between the centers C3 and C4 is comprised between 0.5 and 3 mm and is preferably of the order of 1.5 mm, thereby enabling the device 1 to compensate for an offset (between the centers of the circles of the circular orifices 7, 9A and 9B) of between 1 and 6 mm and preferably as much as 3 mm.

As depicted in FIG. 2, the orifice 7 in the fixing lug 5 is provided with a ring 19 mounted as a tight fit, as specified below. This ring 19 has substantially the same length (namely dimension along the axis X-X) as the orifice 7.

In addition, the orifice 9A in the branch 8A of the clevis 6 is provided with a ring 20A, which is mounted as a tight fit. This ring 20A has substantially the same length (namely dimension along the axis X-X) as the orifice 9A. Likewise, the orifice 9B in the branch 8B of the clevis 6 is also provided with a ring 20B, which is mounted as a tight fit. This ring 20B also have substantially the same length as the orifice 9B.

In addition, the orifice 7 in the fixing lug 5 is provided with a ring 19 which is mounted as a tight fit. Moreover, a clearance 21A, of a length for example of the order of 1.5 mm, is provided between the bushing 16A and the ring 19, making it possible to prevent these two elements from coming into contact with one another. Likewise, a clearance 21B, of a length for example of the order of 1.5 mm, is provided between the bushing 16B and the ring 19, making it possible to prevent these two elements from coming into contact with one another.

The main sleeve 10 has an internal surface 24 delimiting an internal cavity of a slightly frustoconical shape, with a small cone angle (with respect to the axis X-X) comprised, by way of illustration, between 0.5 mm and 5 mm and for example of the order of 1 mm. The diameter of the frustoconical shape increases in the direction illustrated by an arrow I1 in FIG. 2, namely from the branch 8A toward the branch 8B.

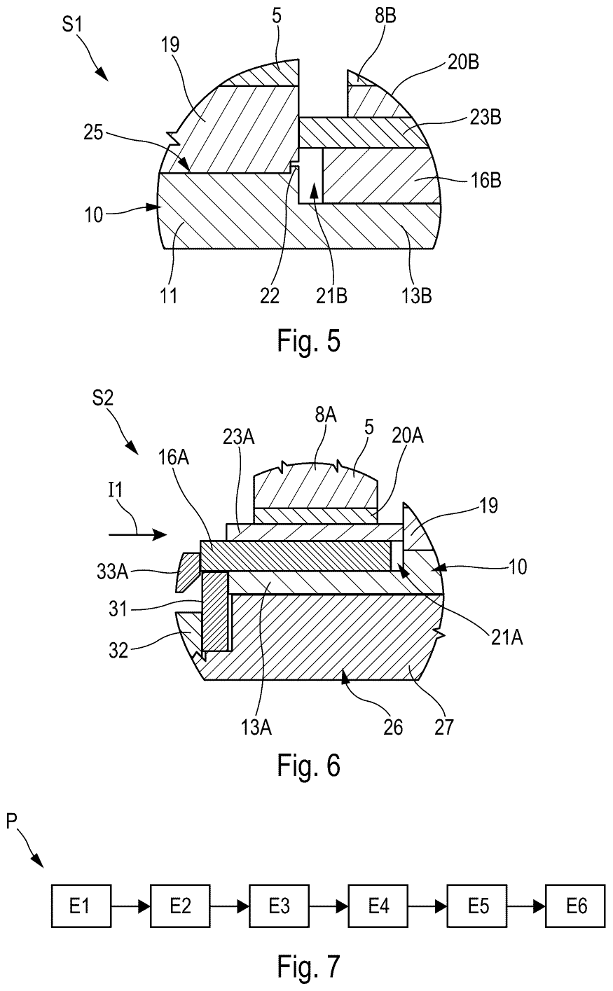

In addition, the central section 11 of the main sleeve 10 is provided, at one of its two longitudinal ends, with a flange 22 which projects radially outward, as depicted in enlarged format in FIG. 5. FIG. 5 illustrates an enlarged part S1 of FIG. 2.

This projecting flange 22 delimits a housing 25 (FIG. 5). This housing 25 enables the central section 11 to be longitudinally blocked with respect to the ring 19.

In addition, the device 1 comprises bushings 23A and 23B. Each bushing 23A, 23B is positioned between the ring 20A, 20B and the bushing 16A, 16B. The internal surface 41A, 41B of each bushing 23A, 23B as a slightly frustoconical shape, with a small cone angle (with respect to the axis X-X) comprised, by way of illustration, between 0.5 mm and 5 mm and for example of the order of 1 mm. The bushings 23A and 23B are mounted as a clearance fit. In addition, they are inserted, as specified hereinbelow, until they come into contact with the ring 19, as is clearly visible in FIG. 5 in respect of the bushing 23B.

Each of the bushings 16A and 16B of which the external surface 18A, 18B has a slightly frustoconical shape, with a small cone angle (with respect to the axis X-X) comprised, by way of illustration, between 0.5 mm and 5 mm and for example of the order of 1 mm, is mounted between the end section 13A, 13B and the bushing 23A, 23B. The diameter of the frustoconical shape of the bushing 16A increases in the direction illustrated by an arrow 12 in FIG. 2, from the branch 8B toward the branch 8A, and the diameter of the frustoconical shape of the bushing 16B increases in the direction illustrated by the arrow I1.

In an exemplary embodiment, the device 1 also comprises an internal sleeve 26, produced as a single piece, which is housed inside the main sleeve 10.

The internal sleeve 26 comprises:
a central section 27 provided with a slightly frustoconical external surface 28 with a small cone angle (with respect to the axis X-X) comprised, by way of illustration, between 0.5 mm and 5 mm and for example of the order of 1 mm; and
two end sections 29A and 29B which are situated, respectively, one on each side, longitudinally speaking, of said central section 27. Each end section 29A, 29B is provided with a threaded external surface 30A, 30B.

The external surface 28 of the central section 27 of the internal sleeve 26 is in contact with the internal surface 24 of the main sleeve 10. The internal sleeve 26 is pushed longitudinally into the main sleeve 10, as specified hereinbelow.

The device 1 further comprises, as depicted in FIG. 6 (which illustrates an enlarged part S2 of FIG. 2), a washer 31 in contact on one side with the end section 13A of the main sleeve 10 and on the other side with a nut 32.

The nut 32 is screwed onto the threaded section 30A of the internal sleeve 26 so that it moves in the direction illustrated by the arrow I1 in FIGS. 2 and 6. The washer 31 held in place by the nut 32 blocks the main sleeve 10 against translational movement in the direction of the arrow 12.

The two bushings 16A and 16B are assembled so that they are blocked radially against the bushings 23A and 23B. These elements therefore retain the possibility of translational movement (along the axis X-X) relative to one another. To block this translation, the device 1 comprises a retaining (and clamping) nut 33A, 33B intended to apply pressure to the bushing 16A, 16B, as depicted in FIG. 2.

To do this, this retaining nut 33A, 33B is moved by a conventional nut 35A, 35B, for example of hexagonal type, a washer 34A, 34B being arranged between the retaining nut 33A, 33B and the retaining nut 35A, 35B.

The nut 35A is screwed onto the threaded section 30A of the internal sleeve 26 so that it moves in the direction illustrated by the arrow I1 in FIG. 2, this causing the retaining nut 33A, and therefore also the bushing 16A, to move in the same direction. This translational movement combined with a slightly conical shape of the bushing 16A will expand the bushing 16A, thereby blocking the bushings 16A and 23A.

Likewise, the nut 35B is screwed onto the threaded section 30B of the internal sleeve 26 so that it moves in the direction illustrated by the arrow 12 in FIG. 2, this causing the retaining nut 33B, and therefore also the bushing 16B, to move in the same direction. This translational movement combined with a slightly conical shape of the bushing 16B will expand the bushing 16B, thereby blocking the bushings 16B and 23B.

The device 1 as described hereinabove, and the system 2 comprising this device 1, are fitted using a method P depicted in FIG. 7.

With regard to this method P, when the two structural elements that are to be assembled, such as the keel beam 3 and the fuselage part 4 of the example of FIG. 1, are in place, with fixing elements that are the mutually interacting clevis 6 and fixing plate 5 also in place at each connecting point, a measurement step E1 is first of all conducted. This measurement step E1 of the method P has the objective of measuring any offset there might be between the center of the orifice 7 of the fixing lug 5 and the centers of the orifices 9A and 9B of the branches 8A and 8B of the clevis 6.

Next, a step E2 of fitting the bushings 23A and 23B is performed, during which step the bushings 23A and 23B are positioned in the rings 20A and 20B of the branches 8A and 8B of the clevis 6.

Thereafter, in a fitting step E3, the main sleeve 10 is inserted into the orifices 7, 9A and 9B of the fixing lug 5 and of the clevis 6 from the branch 8B side of the clevis 6, in the direction of the arrow 12 in FIG. 2.

The main sleeve 10 is positioned at the appropriate angular position, accounting for the measured offset between the centers of the orifices 7, 9A and 9B.

The main sleeve 10 is inserted until it comes into contact with the flange (or shoulder) 22. The washer 31 can then be fitted on that side of the branch 8A that is in contact with the end section 13A of the main sleeve 10.

Next, in a subsequent fitting step E4, the internal sleeve 26 is inserted into the main sleeve 10 from the branch 8B side of the clevis 6, in the direction of the arrow 12 in FIG. 2, and at the same time the nut 32 is positioned against the washer 31 so as to accept the threaded section 30A of the internal sleeve 26.

The internal sleeve 26, which has a slightly frustoconical shape, with a small cone angle comprised, by way of illustration, between 0.5 mm and 5 mm and for example of the order of 1 mm, expands the main sleeve 10 and thus blocks same in all directions.

In a subsequent fitting step E5, the bushings 16A and 16B are mounted in the branches 8A and 8B of the clevis 6. During the course of this step E5, the bushings 16A and 16B are positioned in the rings 23A and 23B in the appropriate angular position, accounting for the measured offset between the centers of the orifices 7, 9A and 9B.

The angular positioning of the main sleeve 10 (and therefore of the central section 11 in the orifice 7 of the fixing lug 5) and the angular positioning of the bushings 16A and 16B with respect to the main sleeve 10, are chosen so as to obtain a relative positioning between the circular external surface 12 of the central section 11 and the circular external surfaces 18A and 18B of the bushings 16A and 16B in such a way as to be able to compensate for an error in alignment between the through-orifice 7 of the fixing lug 5 and the through-orifices 9A and 9B of the clevis 6.

Finally, the final elements are mounted in a fitting step E6 of the method P to clamp and retain. More specifically, in this step E6, the retaining nut 33A, the washer 34A and the nut 35A are fitted at the branch 8A end. The nut 35A is screwed onto the threaded section 30A of the internal sleeve 26 so that it moves in the direction illustrated by the arrow I1 in FIG. 2, this causing the washer 34A and the retaining nut 33A to move in the same direction and block the bushing 16A.

In addition, in this step E6, the retaining nut 33B, the washer 34B and the nut 35B are fitted at the branch 8B end. The nut 35B is screwed onto the threaded section 30B of the internal sleeve 26 so that it moves in the direction illustrated by the arrow 12 in FIG. 2, this causing the washer 34B and the retaining nut 33B to move in the same direction and block the bushing 16B.

By virtue of the device 1 and of the method P both as described hereinabove, the fixing lug 5 may be connected to the clevis 6 quickly and simply, with a limited number of manual actions, while at the same time compensating for any offset in alignment there may be between the orifice 7 and the orifices 9A and 9B, namely any offset in a transverse plane between the centers of the circles of the orifices 7, 9A and 9B.

The device 1 as described hereinabove forms part of a fixing system 2 for fixing a first structural element to a second structural element.

In an exemplary application, depicted in FIG. 1, the system 2 is used for fixing one end 3A of the keel beam 3 to part of the fuselage 4 of the aircraft. In the usual way, the keel beam 3 has a U-shaped body with an flat elongate base 36 and two sidewalls 37 and 38 arranged substantially orthogonal to the base 36, on each side thereof. The system 2 comprises a plurality of fixing lugs 5 secured to the fuselage part 4 and a plurality of clevises 6 secured to the end 3A of the keel beam 3.

Each of these fixing lugs 5 is connected to one of the clevises 6 using a connecting device, such as the device 1 described hereinabove.

In an exemplary embodiment, depicted in FIG. 1, a pair of clevises 6 is fixed to each of the sidewalls 37 and 38 of the keel beam 3, at the end 3A.

For each pair, one of the clevises 6 is positioned closer to the base 36 than the other clevis 6. Thus, on the sidewall 37, the clevis 6 disposed at a position 40A in FIG. 1 is situated closer to the base 36 than the clevis 6 disposed at a position 39A. Likewise, on the sidewall 38, the clevis 6 disposed at a position 40B is situated closer to the base 36 than the clevis 6 disposed at a position 39B.

Because the loads applied to the clevises 6 disposed at the positions 40A and 40B close to the base 36 are higher than the loads applied to the clevises 6 disposed at the more distant positions 39A and 39B, it is conceivable to provide, for each of the clevises 6 disposed at the positions 39A and 39B, orifices 9A and 9B of smaller diameter (and also a device 1 of which the constituent elements and notably the main sleeves 10 and the bushings 16A and 16B also have smaller diameters) than the diameters of the clevises 6 disposed at the positions 40A and 40B.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for connecting a fixing lug to a clevis, comprising:
a main sleeve including a central section configured to be inserted into a through-orifice of the fixing lug, the central section having, in cross section, a circular external surface of a first diameter (D1), the main sleeve also comprising two end sections which are connected to said central section, respectively one on each side of the central section, the external surfaces of the two end sections having, in cross section, a circular shape of the one same second diameter (D2), said second diameter (D2) being different than said first diameter (D1), the centers (C2) of said circular external surfaces of the two end sections being offset from the center (C1) of the circular external surface of the central section in a transverse plane; and
two bushings, each of them mounted on one of the end sections with a circular internal surface in contact with the circular external surface of the corresponding end section and intended to be inserted in a through-orifice of the clevis, each of said bushings having an external surface that is circular in cross section and the center (C3) of which is offset from the center (C4) of its circular internal surface.

2. The device according to claim 1, wherein the central section of the main sleeve is provided, at one of its longitudinal ends, with a radially projecting flange.

3. The device according to claim 1, wherein said device comprises an internal sleeve which is housed inside said main sleeve, its external surface being in contact with an internal surface of the main sleeve.

4. The device according to claim 3, wherein said device comprises, associated with each of the bushings, at least one retaining nut which, under the action of a nut screwed onto a threaded section of the internal sleeve, applies pressure to the bushing to block it against translation.

5. The device according to claim 1, wherein said device comprises a nut and a washer for blocking at least the main sleeve against translation.

6. The device according to claim 1, wherein at least one of the following elements has a frustoconical shape:
the main sleeve;
the bushings;
the internal sleeve.

7. A connecting system connecting a first structural element to a second structural element, wherein said system comprises at least a fixing lug secured to the first structural element and at least one clevis secured to the second structural element and wherein the fixing lug is connected to the clevis using a connecting device as the device according to claim 1,
wherein the central section of the main sleeve is inserted into a through-orifice of the fixing lug and of which each of the two bushings is mounted in a through-orifice of the clevis, the angular positioning of the main sleeve and the angular positionings of the bushings with respect to the main sleeve being adapted in order to compensate for any misalignment between the axis of the through-orifice of the fixing lug and the axes of the through-orifices of the clevis.

8. The connecting system according to claim 7, wherein the first structural element corresponds to part of the fuselage and the second structural element corresponds to a keel beam of an aircraft, wherein the connecting system comprises a plurality of fixing lugs secured to the fuselage part and a plurality of clevises secured to one end of the keel beam.

9. A method for fitting the connecting system according to claim 7, comprising:
a step (E3) of fitting the main sleeve into the orifices of the fixing lug and of the clevis, the main sleeve being angularly positioned in a first position;
a step (E5) of fitting the bushings, each of the bushings being angularly positioned in a second position, the first position and the second positions being adapted in order to compensate for any misalignment between the axis of the through-orifice of the fixing lug and the axes of the through-orifices of the clevis; and
a step (E6) of fitting clamping and retaining elements.

10. The method according to claim 9, further comprising a step (E4) of fitting the internal sleeve inside the main sleeve.
